(19) United States
(12) Patent Application Publication
(10) Pub. No.: US 2004/0004931 A1
(43) Pub. Date: Jan. 8, 2004

(54) Compact disc of circular and non-circular shape

(76) Inventor: Bohumil Pergl, Lodenice (CZ)

Correspondence Address: NOTARO AND MICHALOS, 100 DUTCH HILL ROAD, SUITE 110, ORANGEBURG, NY, 10962-2100, US

(21) Appl. No.: 10/602,131

(22) Filed: Jun. 24, 2003

Related U.S. Application Data
(63) Continuation-in-part of application No. 09/805,345, filed on Mar. 13, 2001.

(30) Foreign Application Priority Data
Mar. 15, 2000 (CZ) 2000-10508

(51) Int. Cl. G11B 7/26

(52) U.S. Cl. 369/283

(57) ABSTRACT

A compact disc of circular and non-circular shape with a disc body comprising a central annular portion and a recording portion provided with a recording and reflective layer, protective coating and optionally with printing and used for special purposes such as advertisement, promotion, corporate presentations which is in the recording or a the central annual portion of the disc provided by at least one defined area containing a hidden printing and covered by a scratch-off paint.

### FIELD AND BACKGROUND OF THE INVENTION

The invention relates to a compact disc of circular or non-circular shape with a disc body comprising a central annular portion and a recording portion provided with a recording and reflective layer, protective coating and optionally with printing on a top side, and used for special purposes such as advertisement, promotion, corporate presentations etc.

### DESCRIPTION OF THE RELATED ART

It is generally known that compact discs, in abbreviation CD, for recording, storing and reproducing information may besides the conventional circular shape being 120 mm or 80 in diameter have also a non-circular shape used mainly for the purpose of advertisement promotion or corporate presentation actions. It is to be understood that the term compact disc used herein includes also compact recordable or re-writable discs designated as CD-R; CD-RW, digital versatile or digital video discs designated as DVD and other similar media. The manufacturers apply various methods in the effort to attract the attention of clients by means of compact discs, for example by producing discs in various shapes, by printings executed in conspicuous, attractive colors, by admixing perfumes, using holograms etc.

U.S. Pat. No. 5,882,555 describes non-round shaping for compact discs bearing digital information. In order to achieve proper alignment of the conventional label put before the shaping process on the upper nonfunctional face of the disc with respect to the shape of the final product, a so-called alignment mark on the substrate to align it with the corresponding mark on the manufacturing platform. No special technology or composition of the label is disclosed.

U.S. Pat. No. 5,791,990 is directed to a method of playing a computerized game in connection with a lottery system, more specifically to improve the known WinWare system that combines a ticket and compact disc. Certain security features are incorporated to avoid fraudulent redemption of the WinWare tickets such as to provide interactive security link between the ticket and the computer game media—called as magnetic media—so that only after playing the game upon activation thereof by a code on the ticket the program reveals the redemption code by which the ticket is to be subsequently modified by the player. Alternatively, an opaque, scratch-off coating may be provided on the ticket to reveal the activation code. Although the patent indicates that either or both the ticket and magnetic media may contain an activation code the description, examples and claims refer and describe the use of an activation code, alternatively provided with an opaque scratch-off coating, only in relation to the ticket without any suggestion of how to apply an activation code to a magnetic media and to use it.

None of the above patents, as well as other known designs, discloses the of compact discs as tickets for a lottery, as a hidden advertisement carrier, etc.

### SUMMARY OF THE INVENTION

The object of this invention is to improve the existing compact discs of circular and non-circular shape with a disc body comprising a central annular portion and a recording portion provided with a recording and a reflective layer, protective coating and optionally with printing on a top side and which are designed to be used for special purposes such as advertisement, promotion and corporate presentations, by providing the upper surface of the disc by at least one defined area containing a hidden printing and covered by a scratch-off paint.

The main advantage of the invention is that the compact disc is provided in at least one defined area by a special scratch-off paint that may be easily removed by means of a coin or nail and that makes it possible to place under this cover paint a hidden information and to make use of such an surprising effect for an effective advertisement, promotion action, etc.

An important advantage of this improvement in the compact disc design is that it may be used as a lottery ticket. In such a case the hidden numerals may by safely printed by so-called ink jet technology. Further, a compact disc of said embodiment may be used as an advertisement carrier containing a hidden advertisement, slogan, etc.

Another object of the invention is to provide means which ensure that the hidden printing is safely protected when the scratch-off paint is applied to and subsequently removed from the defined area of the compact disc. This is achieved by a special interlayer coating covering and slightly overlapping the boarders of the defined area and showing a pre-determined thickness range.

In certain embodiments it may be advantageous that the surface of the defined area covered by a scratch-off paint is provided by an additional guidance printing with an information relating to the contents of the hidden printing.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 shows a portion of a compact disc provided with two defined scratch-off areas;

FIG. 2 shows a detailed sectional view on the line A-A of FIG. 1 illustrating particular layers of the disc to a highly enlarged scale;

FIG. 3 shows a detailed sectional view on the line A-A of FIG. 1 illustrating particular disc layers with a guidance printing;

FIG. 4 shows a detailed sectional view on the line B-B of FIG. 1 of the central annular portion of the disc;

FIG. 5 shows a detailed sectional view illustrating individual disc layers where the defined scratch-off area is on the surface provided by a basic cover paint;

FIG. 6 shows a plan view of a compact disc having a circular shape provided with two defined scratch-off areas;

FIG. 7 shows a plan view of a compact disc in the non-circular shape of a tree provided with one defined scratch-off area;

FIG. 8 a plan view of a compact disc in the non-circular shape performed as a business card provided with one defined scratch-off area;

FIG. 9 shows a compact disc of FIG. 2 provided in addition with a translucent interlayer coating;

FIG. 10 shows a compact disc of FIG. 3 provided in addition with a translucent interlayer coating;

FIG. 11 shows a compact disc of FIG. 4 provided in addition with a translucent interlayer coating; and

FIG. 12 shows a compact disc of FIG. 5 provided in addition with a translucent interlayer coating.

### DESCRIPTION OF THE PREFERRED EMBODIMENTS

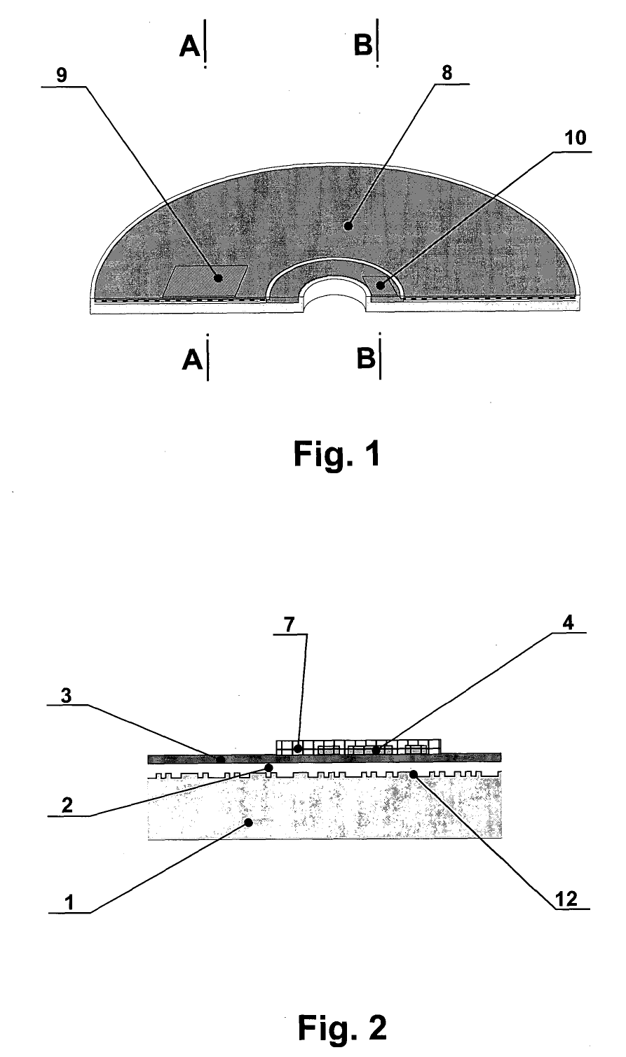

Referring now to the drawings, in which like reference numerals are used to refer to the same or similar elements, FIG. 1 shows a perspective view of a conventional compact disc in section whose top surface 8 which is not designed for scanning, contains two defined areas 9, 10 provided with a scratch-off paint 7.

FIG. 2 shows a partial sectional view of the compact disc to a highly enlarged scale on the line AA of FIG. 1 specifically of the defined area 9 having a border and central portion, which indicates that a disc body 1 includes a spiral or concentric groove with a recording layer 12 and is covered by a reflective layer 2 that enables to make a record in the recording layer 12 and to scan the information data contained in the groove and the recording layer by reflecting it to a recording or scanning apparatus, not shown in the drawing. The reflective layer 2 is covered by a protective coating 3 bearing in a defined area 9 a hidden printing 4. The hidden printing 4 is in the respective defined area 9 and/or 10 covered by a scratch-off paint 7 that functions as a cover paint.

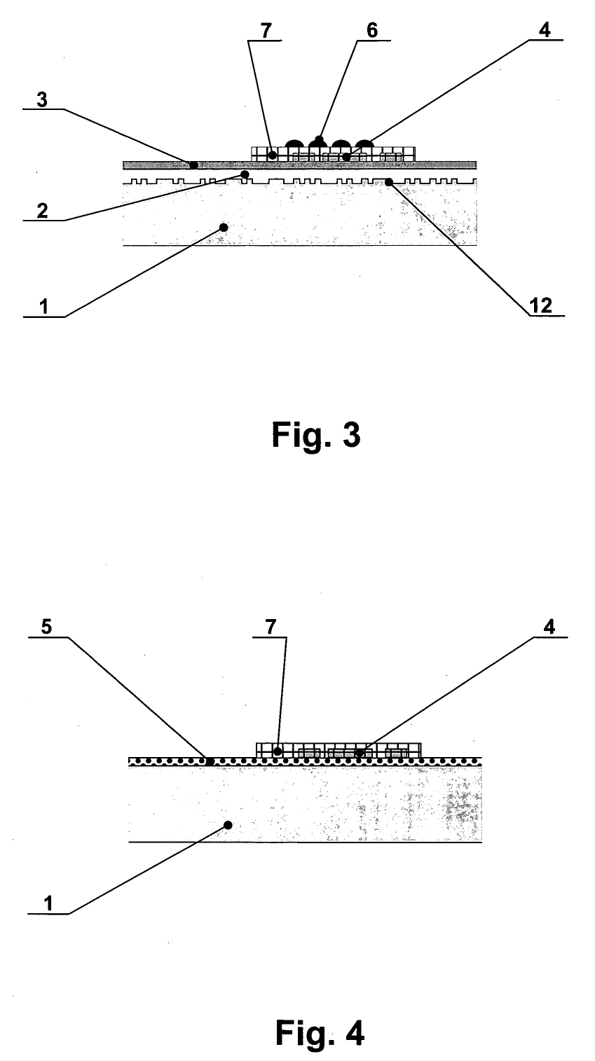

FIG. 3 shows an embodiment of a compact disc which is similar to that in FIG. 2 with the exception that the scratch-off paint 7 bears an upper guidance printing 6 that may contain certain data related to the information of the hidden printing 4.

FIG. 4 shows a partial detailed sectional view of a compact disc on the line B-B and the defined area 10 of FIG. 1 where the defined area 10 is situated in the annular, central portion of the compact disc that does not contain a reflective layer. Here, the reflective layer 2 is replaced by a basic cover paint 5 including a basic printing. Like in the preceding embodiments the hidden printing 4 is covered by the scratch-off paint 7.

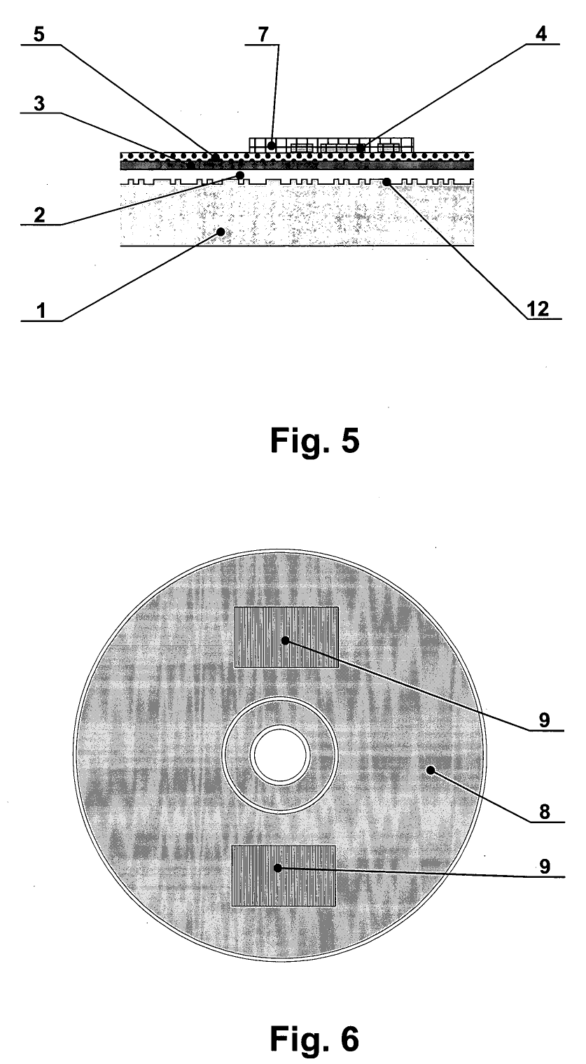

FIG. 5 shows an embodiment which is similar to that in FIG. 2 which differs only in that the protective coating 3 includes a basic cover paint 5 that includes a printing and is further provided with the hidden printing 4 covered by the scratch-off paint 7.

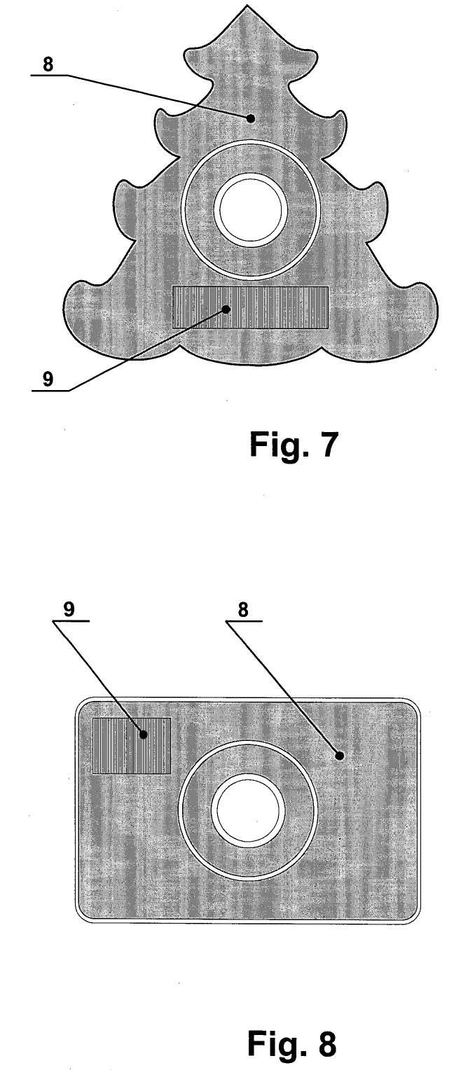

FIGS. 6, 7, and 8 show a plan view of the top surface of the body 1 of a compact disc in three different shapes such as circular, tree and rectangular shape—performed as a business card. In these embodiments the defined area 9 bearing the scratch-off paint 7 is situated in the portion of the disc containing a recording and reflective layer.

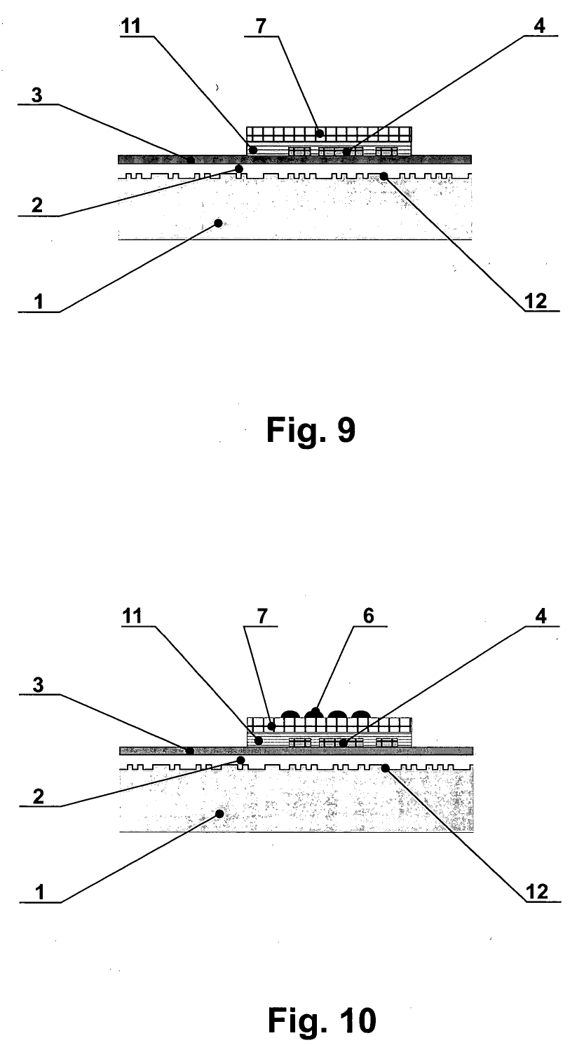

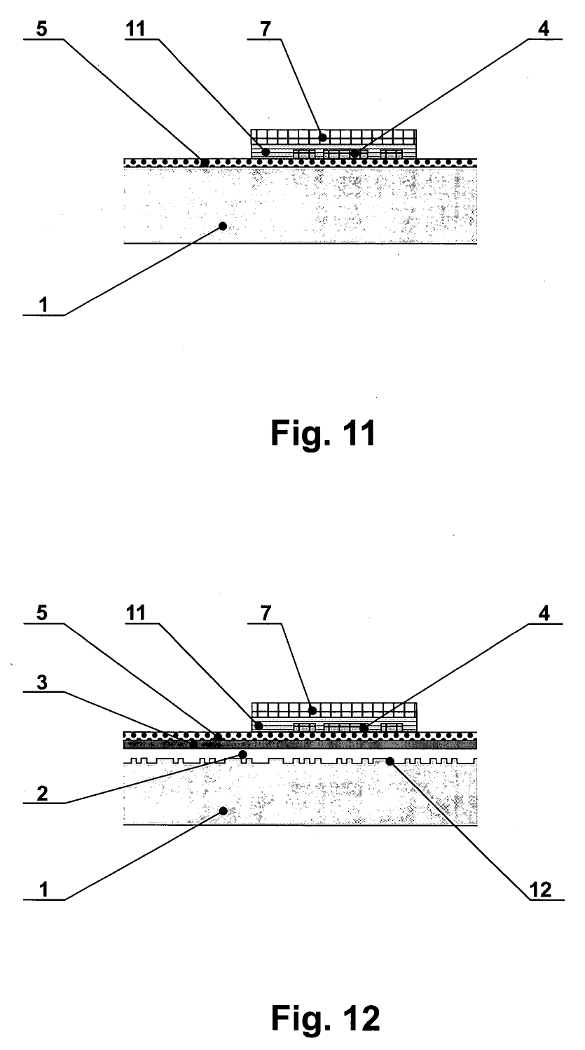

According to still another embodiment of the invention the hidden printing 4 is provided by a translucent interlayer coating 11 that protects the hidden printing 4 when the scratch-off paint 7 is applied to and subsequently removed from the defined area 9,10 of a compact disc. It has proved to be satisfactory, when the translucent interlayer coating 11 is from 40 to 58 microns (μ) in thickness and overlaps the boarder portion of the defined area 9,10 by not less than 2 mm. FIGS. 9, 10, 11 and 12 show the respective embodiment of FIGS. 2, 3, 4, 5 completed by the translucent interlayer coating 11.

The scratch-off paint 7 is a special developed paint used to cover a hidden printed information and available on the market under similar indication. As scratch-off paint thinner based paint, UV radiation or air hardening paint may be used. An UV radiation hardening paint may be for example based on a acrylate-phenylketene compound combination; thinner based paints may contain a thinner known under a commercial name “Stoddard” or “Naptha”. The basic feature of such paintss shall be that even if hardened they may be easily mechanically removed without affecting a hidden printing underneath. The translucent interlayer coating is to be resistant to a deformation and should enable easy reading of the hidden printing. Typically, such coating may be based on polymerizable compounds such as acrylates and acrylic acid.

As print inks used for the creation of a color picture on the top side of the compact disc UV radiation hardening print inks have been used the main component of which was a low viscous reactive acrylate. The protective coating 3 was made of UV radiation hardening transparent paint that prevents the reflective layer from oxidation and which basic component is acrylate (95%).

### INDUSTRIAL APPLICABILITY

A compact disc of circular or a non-circular shape may besides its function as a recording media fulfill an additional function as an advertisement promotional, commercial or a lottery information.

While a specific embodiment of the invention has been shown and described in detail to illustrate the application of the principles of the invention, it will be understood that the invention may be embodied otherwise without departing from such principles.

What is claimed is:

1. A compact disc of circular and non-circular shape comprising:
a disc body having a central annular portion and a recording portion;
a recording and reflective layer provided on the recording portion of the disc body and covered by a protective coating;
a basic cover paint applied to said annular portion;
at least one defined area with a border and central portion situated in the annular or recording portion containing a hidden printing; and
a scratch-off paint coating covering said defined area.

2. A compact disc of claim 1, wherein the defined area printing is separated from the scratch-off paint by a translucent interlayer coating for protecting the hidden printing when applying and removing the scratch-off paint.

3. A compact disc of claim 2, wherein the interlayer coating overlaps the boarder portion of the defined area by at least 2 mm.

4. A compact disc of claim 3, wherein the thickness of the interlayer coating is in the range from 40 to 58 microns.

5. A compact disc of claim 1, wherein the scratch-off paint coating bears a guidance printing.

6. A compact disc of circular and non-circular shape comprising:
a disc body having a central annular portion and a recording portion;
a recording and reflective layer provided on the recording portion of the disc body and covered by a protective coating;
a basic cover paint applied to said annular portion;
at least one defined area with a border and central portion situated in the annular or recording portion and containing a hidden printing;
a translucent interlayer coating covering the defined area; and
a scratch-off paint coating applied to said interlayer coating.

7. A compact disc of claim 6, wherein the translucent interlayer coating is from 40 to 58 microns in thickness and overlaps the boarder portion of the defined area by at least 2 mm.
